(19) United States
(12) Patent Application Publication
(10) Pub. No.: US 2020/0348784 A1
(43) Pub. Date: Nov. 5, 2020

(54) TOUCH DISPLAY SUBSTRATE, METHOD OF MANUFACTURING THE SAME AND DISPLAY DEVICE

(71) Applicants: ORDOS YUANSHENG OPTOELECTRONICS CO., LTD.; BOE TECHNOLOGY GROUP CO., LTD.

(72) Inventors: Xinguo WU, Beijing (CN); Fengguo WANG, Beijing (CN); Zhixuan GUO, Beijing (CN); Hong LIU, Beijing (CN); Bo MA, Beijing (CN); Kai LI, Beijing (CN); Liang TIAN, Beijing (CN); Shicheng SONG, Beijing (CN)

(73) Assignees: ORDOS YUANSHENG OPTOELECTRONICS CO., LTD., Ordos, Inner Mongolia (CN); BOE TECHNOLOGY GROUP CO., LTD., Beijing (CN)

(21) Appl. No.: 16/763,105

(22) PCT Filed: Apr. 15, 2019
(86) PCT No.: PCT/CN2019/082655

§ 371 Date: May 11, 2020

(51) Int. Cl. G06F 3/041

(52) U.S. Cl. CPC G06F 3/0412; G06F 2203/04103; G06F 3/04164

(57) ABSTRACT

A touch display substrate includes a common electrode, a common electrode line connected to the common electrode, a touch electrode, and a touch signal line connected to the touch electrode, wherein the common electrode is multiplexed as the touch electrode, and the common electrode line is multiplexed as the touch signal line, wherein the touch display substrate further comprises an inorganic insulation layer arranged between the touch electrode and the touch signal line, the touch electrode is electrically connected to the touch signal line through a via-hole penetrating through the inorganic insulation layer, and the touch electrode, the inorganic insulation layer and the touch signal line are stacked in sequence.

### TECHNICAL FIELD

The present disclosure relates to the field of display technology, in particular to a touch display substrate, a method of manufacturing the same and a display device.

### BACKGROUND

In order to simplify a structure, each common electrode of a conventional touch display substrate is multiplexed as a touch electrode, and each common electrode line is multiplexed as a touch signal line. An organic resin layer is arranged between the touch signal line and the touch electrode, and the touch signal line is connected to the touch electrode through a via-hole penetrating through the organic resin layer, so as to achieve a touch function. The touch electrode is located at a bottom of the via-hole and lapped onto the touch signal line. Due to a relatively large thickness of the organic resin layer, a lap resistance between the touch electrode and the touch signal line at the via-hole is relatively large. In addition, a volatile matter is easily generated when organic resin is in a high-temperature or plasma environment, and an electrical connection state at the via-hole may be adversely affected by the volatile matter. In this regard, during the display, unequal common voltage signals are applied to the touch electrodes, and the display uniformity may be adversely affected due to the abnormal common voltage signals.

### SUMMARY

The present disclosure provides a touch display substrate, a manufacturing method thereof, and a display device.

In one aspect, the present disclosure provides in some embodiments a touch display substrate, including a common electrode, a common electrode line connected to the common electrode, a touch electrode, and a touch signal line connected to the touch electrode, wherein the common electrode is multiplexed as the touch electrode, and the common electrode line is multiplexed as the touch signal line, wherein the touch display substrate further comprises an inorganic insulation layer arranged between the touch electrode and the touch signal line, the touch electrode is electrically connected to the touch signal line through a via-hole penetrating through the inorganic insulation layer, and the touch electrode, the inorganic insulation layer and the touch signal line are stacked in sequence.

In a possible embodiment of the present disclosure, the touch display substrate includes a plurality of touch signal lines, the touch electrode comprises a plurality of touch sub-electrodes independent of each other and corresponding to the touch signal lines in a one-to-one manner, and each touch sub-electrode is connected to the corresponding touch signal line

In a possible embodiment of the present disclosure, the inorganic insulation layer has a thickness not greater than 1000 nm.

In a possible embodiment of the present disclosure, the inorganic insulation layer is arranged at a side of the touch electrode away from a base substrate of the touch display substrate, and the touch signal line is arranged at a side of the inorganic insulation layer away from the touch electrode.

In a possible embodiment of the present disclosure, the touch display substrate includes: the base substrate; a thin film transistor (TFT) array arranged on the base substrate; a planarization layer covering the TFT array; the touch electrode arranged on the planarization layer; the inorganic insulation layer covering the touch electrode; and a pixel electrode and the touch signal line arranged on the inorganic insulation layer, the pixel electrode being connected to a drain electrode of a corresponding TFT through a via-hole penetrating through the planarization layer and the inorganic insulation layer, and the touch signal line being connected to the touch electrode through the via-hole penetrating through the inorganic insulation layer.

In a possible embodiment of the present disclosure, the touch display substrate further includes a conductive protection pattern arranged in the via-hole and in direct contact with the touch electrode. The touch signal line is in direct contact with the conductive protection pattern and electrically connected to the touch electrode via the conductive protection pattern, and the conductive protection pattern and the pixel electrodes are formed through a single patterning process.

In another aspect, the present disclosure provides in some embodiments a display device including the above-mentioned touch display substrate.

In yet another aspect, the present disclosure provides in some embodiments a method of manufacturing a touch display substrate. The touch display substrate includes a common electrode, a common electrode line connected to the common electrode, a touch electrode, and a touch signal line connected to the touch electrode, the common electrode is multiplexed as the touch electrode, and the common electrode line is multiplexed as the touch signal line, wherein the method includes: forming one of the touch electrode and the touch signal line; forming an inorganic insulation layer and forming a via-hole in the inorganic insulation layer through a patterning process; and forming the other of the touch electrode and the touch signal line, the touch electrode being electrically connected to the touch signal line through the via-hole penetrating through the inorganic insulation layer.

In a possible embodiment of the present disclosure, the inorganic insulation layer has a thickness not greater than 1000 nm.

In a possible embodiment of the present disclosure, the method includes: forming the touch electrode; forming the inorganic insulation layer covering the touch electrodes, and patterning the inorganic insulation layer to form the via-hole for exposing the touch electrode; and forming the touch signal line on the inorganic insulation layer, the touch signal line being connected to the touch electrode through the via-hole.

In a possible embodiment of the present disclosure, prior to forming the touch electrode, the method further includes: providing a base substrate and forming a TFT array on the base substrate; and forming a planarization layer covering the TFT array. The forming the touch electrode includes forming the touch electrode on the planarization layer. Subsequent to forming the inorganic insulation layer and prior to forming the touch signal lines on the inorganic insulation layer, the method further includes forming a pixel electrode on the inorganic insulation layer, the pixel electrode being connected to a drain electrode of a TFT through a via-hole penetrating through the planarization layer and the inorganic insulation layer.

In a possible embodiment of the present disclosure, in a same patterning process for forming the pixel electrode, the method further includes forming a conductive protection pattern in the via-hole and in direct contact with the corresponding touch electrode. The forming the touch signal line includes: forming the touch signal line on the inorganic insulation layer provided with the pixel electrode and the conductive protection pattern, and the touch signal line being in direct contact with the conductive protection pattern and electrically connected to the touch electrode through the conductive protection pattern.

### BRIEF DESCRIPTION OF THE DRAWINGS

FIG. 1 is a schematic view showing a conventional touch display substrate;

FIG. 2 is a schematic view showing a distance between a touch electrode and a pixel electrode in the conventional touch display substrate;

FIG. 3 is a schematic view showing a situation where a touch electrode is connected to a touch signal line according to one embodiment of the present disclosure;

FIG. 4 is a planar view of a touch display substrate according to one embodiment of the present disclosure; and

FIG. 5 is a sectional view of the touch display substrate according to one embodiment of the present disclosure.

### REFERENCE SIGN LIST

1 base substrate
2 light-shielding layer
3 buffer layer
4 active layer
5 gate insulation layer
6 intermediate insulation layer
7 planarization layer
8 organic resin layer
9 touch electrode
10 passivation layer
11 pixel electrode
12 touch signal line
13 source-drain metal layer pattern
14 touch electrode via-hole
15 gate metal layer pattern
16 conductive protection pattern

### DETAILED DESCRIPTION

In order to make the objects, the technical solutions and the advantages of the present disclosure more apparent, the present disclosure will be described hereinafter in a clear and complete manner in conjunction with the drawings and embodiments.

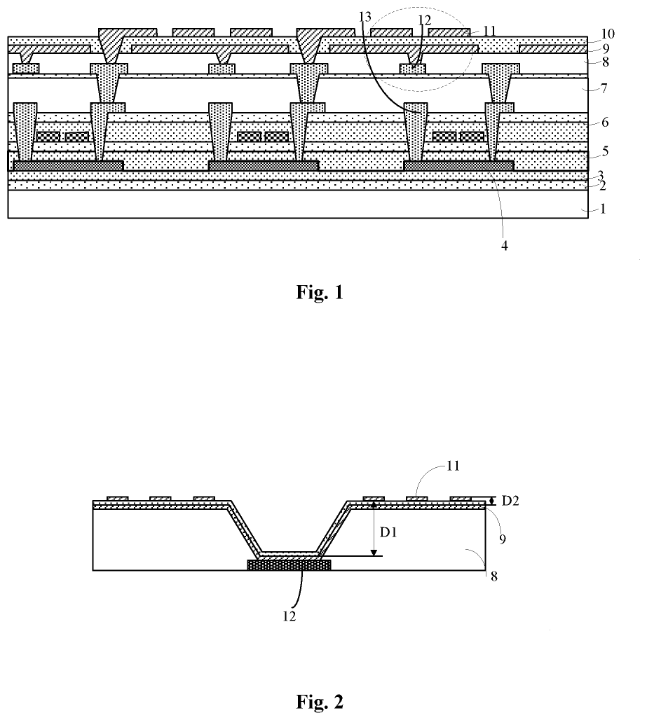

In the related art, in order to provide an in-cell touch panel for a liquid crystal display panel, new layers need to be provided on the basis of an array substrate of the liquid crystal display panel, so as to manufacture a touch display substrate through several patterning processes. As shown in FIG. 1, a conventional touch display substrate includes a base substrate 1, a light-shielding layer 2 arranged on the base substrate 1, a buffer layer 3 arranged on the light-shielding layer 2, an active layer 4 arranged on the buffer layer 3, a gate insulation layer 5, an intermediate insulation layer 6, a planarization layer 7, touch signal lines 12 arranged on the planarization layer 7, an organic resin layer 8 covering the touch signal lines 12, touch electrodes 9 arranged on the organic resin layer 8 and each connected to the corresponding touch signal line 12 through a via-hole penetrating through the organic resin layer 8, a passivation layer 10 covering the touch electrodes 9, and pixel electrodes 11 arranged on the passivation layer 10 and each connected to a drain electrode of a TFT through a via-hole penetrating through the passivation layer 10, the organic resin layer 8 and the planarization layer 7. In order to simplify the structure, each touch electrode 9 is multiplexed as, i.e., serves as, a common electrode, and each touch signal line 12 is multiplexed as, i.e., serves as, a common electrode line.

As shown in FIG. 1, in the conventional touch display substrate, each touch signal line 12 is arranged between the corresponding touch electrode 9 and the base substrate 1. Because each touch electrode 9 needs to be formed on a flat surface, it is necessary to provide the organic resin layer 8 on the touch signal lines 12, so as to provide the flat surface for the subsequent formation of the touch electrodes 9. In addition, in order to enable the pixel electrodes 11 to be insulated from the touch electrodes 9, it is also necessary to provide the passivation layer 10 covering the touch electrodes 9.

As shown in FIG. 2, at the via-hole in the organic resin layer 8, each touch electrode 9 is located at a bottom of the via-hole and lapped onto the corresponding touch signal line 12. Due to a relatively large thickness of the organic resin layer 8, e.g., 1.5 μm to 3.0 μm, a lap resistance between the touch electrode 9 and the touch signal line 12 at the via-hole is relatively large. In this regard, during the display, unequal common voltage signals are applied to the touch electrodes 9, and the display uniformity may be adversely affected due to the abnormal common voltage signals.

Further, as shown in FIG. 2, each pixel electrode 11 is located at a side of the corresponding touch electrode 9 away from the touch signal line 12, and a distance D1 between the touch electrode 9 and the pixel electrode 11 at the via-hole in the organic resin layer 8 is far greater than a distance D2 between the touch electrode 9 and the pixel electrode 11 at the other regions. In this regard, during the display, a tiny driving electric field is generated between the touch electrode 9 and the pixel electrode 11 at the via-hole, resulting in an insufficient capability of controlling liquid crystals. At this time, a color display abnormality, e.g., mura in an oblique direction, easily occurs.

An object of the present disclosure is to provide a touch display substrate, a method of manufacturing the same and a display device, so as to solve the above-mentioned problem.

The present disclosure provides in some embodiments a touch display substrate which includes common electrodes, common electrode lines connected to the common electrodes, touch electrodes, and touch signal lines connected to the touch electrodes. Each common electrode is multiplexed as the touch electrode, and each common electrode line is multiplexed as the touch signal line. The touch display substrate further includes an inorganic insulation layer arranged between the touch electrodes and the touch signal lines. Each touch electrode is electrically connected to the corresponding touch signal line through a via-hole penetrating through the inorganic insulation layer, and the touch electrodes, the inorganic insulation layer and the touch signal lines are stacked in sequence.

When the each common electrode is multiplexed as the touch electrode, it means that the common electrode may also serve as the touch electrode, and when the common electrode line is multiplexed as the touch signal line, it means that the common electrode line may also serve as the touch signal line.

According to the embodiments of the present disclosure, each touch electrode may be electrically connected to the corresponding touch signal line through the via-hole penetrating through the inorganic insulation layer. As compared with the organic resin layer, the inorganic insulation layer has a relatively small thickness, so the lap resistance between the touch electrode and the corresponding touch signal line at the via-hole may be relatively small. In addition, no volatile matter may be generated when the inorganic insulation layer is in the high-temperature or plasma environment, and thereby the electrical connection state at the via-hole may not be adversely affected. As a result, during the display, it is able to apply an equal common voltage signal to the touch electrodes, thereby improve a display effect of the touch display substrate. In addition, during the touch detection, it is able to apply an equal touch signal to the touch electrodes, thereby to ensure a touch effect of the touch display substrate.

Further, due to the relatively small thickness of the inorganic insulation layer, the distance between the touch electrode and the pixel electrode at the via-hole in the inorganic insulation layer may be slightly different from the distance between the touch electrode and the pixel electrode at the other regions. As a result, during the display, it is able to ensure an intensity of the driving electric field generated between the touch electrode and the pixel electrode at the via-hole, thereby to ensure the capability of the controlling the liquid crystals, and prevent the occurrence of the color display abnormality, e.g., the mura in the oblique direction.

In a possible embodiment of the present disclosure, the inorganic insulation layer may have a thickness not greater than 1000 nm, e.g., several dozen or hundred nanometers. In this regard, the lap resistance between the touch electrode and the touch signal line at the via-hole in the inorganic insulation layer may be relatively small. During the display, it is able to apply the equal common voltage signal to the touch electrodes, thereby to improve the display effect of the touch display substrate. In addition, during the touch detection, it is able to apply the equal touch signal to the touch electrodes, thereby to ensure the touch effect of the touch display substrate. When the thickness of the inorganic insulation layer is too small, the insulativity between the touch electrode and the touch signal line may be adversely affected, and when the thickness of the inorganic insulation layer is too large, the lap resistance between the touch electrode and the touch signal line at the via-hole in the inorganic insulation layer may be relatively large. In a possible embodiment of the present disclosure, the thickness of the inorganic insulation layer may be 50 to 500 nm.

Of course, in the embodiments of the present disclosure, the thickness of the inorganic insulation layer may not be limited to be smaller than 1000 nm, e.g., the thickness of the inorganic insulation layer may be 1000 nm or slightly greater than 1000 nm. It is able to reduce the lap resistance between the touch electrode and the touch signal line at the via-hole as if the thickness of the inorganic insulation layer is smaller than that of the conventional organic resin layer, thereby to apply the equal common voltage signal to the touch electrodes during the display.

Further, the touch display substrate may include a plurality of touch signal lines, each touch electrode may include a plurality of touch sub-electrodes independent of each other and corresponding to the touch signal lines respectively, and each touch sub-electrode may be connected to the corresponding touch signal line. In this regard, during the display, it is able to apply the common voltage signal to a corresponding touch sub-electrode via the touch signal line to generate a driving electric field between the touch sub-electrode and the pixel electrode for driving liquid crystal molecules to deflect, and during displaying of the touch display substrate, apply a touch signal to the corresponding touch sub-electrode via the touch signal line to determine a touch position based on an electric signal detected by the touch signal line.

The inorganic insulation layer may be arranged at a side of each touch electrode away from a base substrate of the touch display substrate, and each touch signal line may be arranged at a side of the inorganic insulation layer away from the corresponding touch electrode. Of course, apart from being arranged at the side of each touch electrode away from the base substrate, the inorganic insulation layer may also be arranged at a side of each touch electrode close to the base substrate, and at this time, each touch signal line may be arranged at a side of the inorganic insulation layer close to the base substrate.

In a possible embodiment of the present disclosure, the touch electrodes, the inorganic insulation layer and the touch signal lines may be arranged sequentially in a direction away from the base substrate. The touch electrodes need to be formed at a surface with high flatness, so the touch display substrate may further include a planarization layer covering a TFT array. At this time, the touch electrodes may be arranged on the planarization layer of the touch display substrate. When the touch signal lines, the inorganic insulation layer and the touch electrodes are arranged sequentially on the base substrate, the touch signal lines may be arranged on the planarization layer, the inorganic insulation layer may be arranged on the touch signal lines, and then the touch electrodes may be arranged on the inorganic insulation layer. At this time, due to the relatively small thickness of the inorganic insulation layer, it is probably impossible to meet the requirement of the touch electrodes on the flatness.

In a possible embodiment of the present disclosure, the touch display substrate may specifically include: the base substrate; the TFT array arranged on the base substrate; the planarization layer covering the TFT array; the touch electrodes arranged on the planarization layer; the inorganic insulation layer covering the touch electrodes; and pixel electrodes and the touch signal lines arranged on the inorganic insulation layer, each pixel electrode being connected to a drain electrode of a corresponding TFT through a via-hole penetrating through the planarization layer and the inorganic insulation layer, and each touch signal line being connected to the corresponding touch electrode through the via-hole penetrating through the inorganic insulation layer.

The pixel electrodes are arranged at pixel regions and each touch signal line is arranged between two adjacent pixel regions, so there is no conflict between positions of the pixel electrodes and positions of the touch signal lines, i.e., an orthogonal projection of each pixel electrode onto the base substrate may not coincide with an orthogonal projection of the corresponding touch signal line onto the base substrate. At this time, it is able for each pixel electrode to be insulated from the corresponding touch signal line without any necessity to form the pixel electrodes at a layer different from the touch signal lines, i.e., the pixel electrodes and the touch signal lines may all be arranged on the inorganic insulation layer. Through the inorganic insulation layer, the pixel electrodes may be insulated from the touch electrodes, and the touch electrodes may be insulated from the touch signal lines. In this regard, it is unnecessary to provide an additional insulation film layer between the pixel electrodes and the touch signal lines, thereby to simplify the structure of the touch display substrate, reduce the quantity of the patterning processes for manufacturing the touch display substrate, and reduce the manufacture cost of the touch display substrate.

In a possible embodiment of the present disclosure, the touch display substrate may further include a conductive protection pattern arranged in the via-hole and in direct contact with the corresponding touch electrode. Each touch signal line may be in direct contact with the conductive protection pattern and electrically connected to the corresponding touch electrode via the conductive protection pattern, and the conductive protection pattern and the pixel electrodes may be formed through a single patterning process.

When the pixel electrodes are formed prior to the formation of the touch signal lines, the touch electrode exposed at the via-hole may be easily damaged by an etchant for etching the pixel electrodes. In the embodiments of the present disclosure, during the formation of the pixel electrodes, the conductive protection pattern in direct contact with the touch electrode may be formed at the via-hole through a material for forming the pixel electrodes, so as to protect the touch electrode exposed at the via-hole and prevent the etchant from being in contact with the touch electrode, thereby to prevent the touch electrode exposed at the via-hole from being damaged and ensure the electrical connection state between the touch signal line and the touch electrode.

The present disclosure further provides in some embodiments a display device including the above-mentioned touch display substrate. The display device may be any product or member having a display function, e.g., liquid crystal television, liquid crystal display, digital photo frame, mobile phone or flat-panel computer. The display device may further include a flexible circuit board, a printed circuit board, a back plate, a radio frequency unit, a network module, an audio output unit, an input unit, a sensor, a display unit, a user input unit, an interface unit, a memory, a processor, and a power source. It should be appreciated that, the structure of the display device may not be limited thereto, and the display device may include more or fewer components, or some components may be combined, or the components may be arranged in a different manner.

The present disclosure further provides in some embodiments a method of manufacturing a touch display substrate. The touch display substrate includes common electrodes, common electrode lines connected to the common electrodes, touch electrodes, and touch signal lines connected to the touch electrodes. Each common electrode is multiplexed as the touch electrode, and each common electrode line is multiplexed as the touch signal line. The method includes: forming ones of the touch electrodes and the touch signal lines; forming an inorganic insulation layer and forming a via-hole in the inorganic insulation layer through a patterning process; and forming the other ones of the touch electrodes and the touch signal lines, each touch electrode being electrically connected to the corresponding touch signal line through the via-hole penetrating through the inorganic insulation layer.

When the each common electrode is multiplexed as the touch electrode, it means that the common electrode may also serve as the touch electrode, and when the common electrode line is multiplexed as the touch signal line, it means that the common electrode line may also serve as the touch signal line.

According to the embodiments of the present disclosure, each touch electrode may be electrically connected to the corresponding touch signal line through the via-hole penetrating through the inorganic insulation layer. As compared with the organic resin layer, the inorganic insulation layer has a relatively small thickness, so the lap resistance between the touch electrode and the corresponding touch signal line at the via-hole may be relatively small. In addition, no volatile matter may be generated when the inorganic insulation layer is in the high-temperature or plasma environment, and thereby the electrical connection state at the via-hole may not be adversely affected. As a result, during the display, it is able to apply an equal common voltage signal to the touch electrodes, thereby improve a display effect of the touch display substrate. In addition, during the touch detection, it is able to apply an equal touch signal to the touch electrodes, thereby to ensure a touch effect of the touch display substrate.

In a possible embodiment of the present disclosure, the method may specifically include: forming the touch electrodes; forming the inorganic insulation layer covering the touch electrodes, and patterning the inorganic insulation layer to form the via-hole for exposing each touch electrode; and forming the touch signal lines on the inorganic insulation layer, each touch signal line being connected to the corresponding touch electrode through the via-hole.

Further, due to the relatively small thickness of the inorganic insulation layer, the distance between the touch electrode and the pixel electrode at the via-hole in the inorganic insulation layer may be slightly different from the distance between the touch electrode and the pixel electrode at the other regions. As a result, during the display, it is able to ensure an intensity of the driving electric field generated between the touch electrode and the pixel electrode at the via-hole, thereby to ensure the capability of the controlling the liquid crystals, and prevent the occurrence of the color display abnormality, e.g., the mura in the oblique direction.

In a possible embodiment of the present disclosure, the inorganic insulation layer may have a thickness not greater than 1000 nm, e.g., several dozen or hundred nanometers. In this regard, the lap resistance between the touch electrode and the touch signal line at the via-hole in the inorganic insulation layer may be relatively small. During the display, it is able to apply the equal common voltage signal to the touch electrodes, thereby to improve the display effect of the touch display substrate. In addition, during the touch detection, it is able to apply the equal touch signal to the touch electrodes, thereby to ensure the touch effect of the touch display substrate. When the thickness of the inorganic insulation layer is too small, the insulativity between the touch electrode and the touch signal line may be adversely affected, and when the thickness of the inorganic insulation layer is too large, the lap resistance between the touch electrode and the touch signal line at the via-hole in the inorganic insulation layer may be relatively large. In a possible embodiment of the present disclosure, the thickness of the inorganic insulation layer may be 50 to 500 nm.

Of course, in the embodiments of the present disclosure, the thickness of the inorganic insulation layer may not be limited to be smaller than 1000 nm, e.g., the thickness of the inorganic insulation layer may be 1000 nm or slightly greater than 1000 nm. It is able to reduce the lap resistance between the touch electrode and the touch signal line at the via-hole as if the thickness of the inorganic insulation layer is smaller than that of the conventional organic resin layer, thereby to apply the equal common voltage signal to the touch electrodes during the display.

The inorganic insulation layer may be arranged at a side of each touch electrode away from a base substrate of the touch display substrate, and each touch signal line may be arranged at a side of the inorganic insulation layer away from the corresponding touch electrode. Of course, apart from being arranged at the side of each touch electrode away from the base substrate, the inorganic insulation layer may also be arranged at a side of each touch electrode close to the base substrate, and at this time, each touch signal line may be arranged at a side of the inorganic insulation layer close to the base substrate.

In a possible embodiment of the present disclosure, the touch electrodes, the inorganic insulation layer and the touch signal lines may be arranged sequentially in a direction away from the base substrate. The touch electrodes need to be formed at a surface with high flatness, so the touch display substrate may further include a planarization layer covering a TFT array. At this time, the touch electrodes may be arranged on the planarization layer of the touch display substrate. When the touch signal lines, the inorganic insulation layer and the touch electrodes are arranged sequentially on the base substrate, the touch signal lines may be arranged on the planarization layer, the inorganic insulation layer may be arranged on the touch signal lines, and then the touch electrodes may be arranged on the inorganic insulation layer. At this time, due to the relatively small thickness of the inorganic insulation layer, it is probably impossible to meet the requirement of the touch electrodes on the flatness.

In a possible embodiment of the present disclosure, prior to forming the touch electrodes, the method may further include: providing a base substrate and forming a TFT array on the base substrate; and forming a planarization layer covering the TFT array. The forming the touch electrodes may include forming the touch electrodes on the planarization layer. Subsequent to forming the inorganic insulation layer and prior to forming the touch signal lines on the inorganic insulation layer, the method may further include forming pixel electrodes on the inorganic insulation layer, each pixel electrode being connected to a drain electrode of a corresponding TFT through a via-hole penetrating through the planarization layer and the inorganic insulation layer.

The pixel electrodes are arranged at pixel regions and each touch signal line is arranged between two adjacent pixel regions, so there is no conflict between positions of the pixel electrodes and positions of the touch signal lines, i.e., an orthogonal projection of each pixel electrode onto the base substrate may not coincide with an orthogonal projection of the corresponding touch signal line onto the base substrate. At this time, it is able for each pixel electrode to be insulated from the corresponding touch signal line without any necessity to form the pixel electrodes at a layer different from the touch signal lines, i.e., the pixel electrodes and the touch signal lines may all be arranged on the inorganic insulation layer. Through the inorganic insulation layer, the pixel electrodes may be insulated from the touch electrodes, and the touch electrodes may be insulated from the touch signal lines. In this regard, it is unnecessary to provide an additional insulation film layer between the pixel electrodes and the touch signal lines, thereby to simplify the structure of the touch display substrate, reduce the quantity of the patterning processes for manufacturing the touch display substrate, and reduce the manufacture cost of the touch display substrate.

In a possible embodiment of the present disclosure, in a single patterning process for forming the pixel electrodes, the method may further include forming a conductive protection pattern in the via-hole and in direct contact with the corresponding touch electrode. The forming the touch signal lines may include forming the touch signal lines on the inorganic insulation layer provided with the pixel electrodes and the conductive protection pattern, and each touch signal line may be in direct contact with the conductive protection pattern and electrically connected to the corresponding touch electrode through the conductive protection pattern.

When the pixel electrodes are formed prior to the formation of the touch signal lines, the touch electrode exposed at the via-hole may be easily damaged by an etchant for etching the pixel electrodes. In the embodiments of the present disclosure, during the formation of the pixel electrodes, the conductive protection pattern in direct contact with the touch electrode may be formed at the via-hole through a material for forming the pixel electrodes, so as to protect the touch electrode exposed at the via-hole and prevent the etchant from being in contact with the touch electrode, thereby to prevent the touch electrode exposed at the via-hole from being damaged and ensure the electrical connection state between the touch signal line and the touch electrode.

The touch display substrate will be described hereinafter in more details in conjunction with the drawings and embodiments. The method of manufacturing the touch display substrate may include the following steps.

Step 1: providing a base substrate 1, and forming a light-shielding layer 2 on the base substrate. The base substrate 1 may be a glass or quartz substrate. The light-shielding layer 2 may be made of a nontransparent metal material or a light-shielding insulation material, so as to shield an active layer of each TFT. An orthogonal projection of the active layer of each TFT onto the base substrate 1 may fall within an orthogonal projection of the light-shielding layer 2 onto the base substrate 1. Through the light-shielding layer 2, it is able to prevent light from a backlight module from reaching the active layer of each TFT, thereby to prevent the performance of the TFT from being adversely affected.

Step 2: forming a buffer layer 3. The buffer layer 3 may be made of an inorganic insulation material, e.g., an oxide, a nitride or an oxynitride. Through the buffer layer 3, it is able to prevent metallic ions in the base substrate 1 from moving into each TFT, thereby to prevent the performance of the TFT from being adversely affected.

Step 3: forming the active layer 4. To be specific, a semiconductor material, e.g., an amorphous silicon (a-Si) material, may be coated onto the buffer layer 3. Next, a photoresist may be applied onto the semiconductor material, and then exposed with a mask plate, so as to form a photoresist reserved region corresponding to a region where a pattern of the active layer is located and a photoresist unreserved region corresponding to the other region. Next, the photoresist may be developed, so as to full remove the photoresist at the photoresist unreserved region, and maintain a thickness of the photoresist at the photoresist reserved region. Then, the semiconductor material at the photoresist unreserved region may be etched off through an etching process so as to form the pattern of the active layer 4 as an active layer of each TFT at the pixel regions and a Gate Driver on Array (GOA) region.

Step 4: forming a gate insulation layer 5. To be specific, the gate insulation layer 5 having a thickness of 500 to 5000 Å may be deposited onto the base substrate acquired after Step 3 through Plasma Enhanced Chemical Vapor Deposition (PECVD). The gate insulation layer 5 may be made of an oxide, a nitride or an oxynitride, with a reactive gas of SiH₄, NH₃ or N₂, or SiH₂Cl₂, NH₃ or N₂.

Step 5: forming a gate metal layer pattern 15. To be specific, a gate metal layer having a thickness of about 500 to 4000 Å may be deposited onto the base substrate 1 acquired after Step 4 through sputtering or thermal evaporation. The gate metal layer may be made of Cu, Al, Ag, Mo, Cr, Nd, Ni, Mn, Ti, Ta, W or an alloy thereof, and it may be of a single-layered structure, or a multi-layered structure e.g., Cu/Mo, Ti/Cu/Ti, or Mo/Al/Mo. Next, a photoresist may be applied onto the gate metal layer, and then exposed with a mask plate so as to form a photoresist reserved region corresponding to a region where the gate metal layer pattern 15 is located and a photoresist unreserved region corresponding to the other region. Next, the photoresist may be developed so as to fully remove the photoresist at the photoresist unreserved region and maintain a thickness of the photoresist at the photoresist reserved region. Then, the gate metal layer at the photoresist unreserved region may be etched off through an etching process, and the remaining photoresist may be removed, so as to form the gate metal layer pattern 15. The gate metal layer pattern 15 may include gate lines and gate electrodes for controlling an on state and an off state of each TFT.

Step 6: forming an intermediate insulation layer 6. To be specific, the intermediate insulation layer 6 having a thickness of 500 to 5000 Å may be deposited onto the base substrate 1 acquired after Step 5 through PECVD. The intermediate insulation layer 6 may be made of an oxide, a nitride or an oxynitride, with a reactive gas of SiH₄, NH₃ or N₂, or SiH₂Cl₂, NH₃ or N₂. Through the intermediate insulation layer 6, it is able to insulate the gate metal layer pattern 15 from a source-drain metal layer pattern 13.

Step 7: forming the source-drain metal layer pattern 13. To be specific, a source-drain metal layer having a thickness of about 2000 to 4000 Å may be deposited onto the base substrate 1 acquired after Step 6 through magnetron-sputtering, thermal evaporation or any other film-forming process. The source-drain metal layer may be made of Cu, Al, Ag, Mo, Cr, Nd, Ni, Mn, Ti, Ta or W, or an alloy thereof, and it may be of a single-layered structure, or a multi-layered structure e.g., Cu/Mo, Ti/Cu/Ti, or Mo/Al/Mo. Next, a photoresist may be applied onto the source-drain metal layer, and exposed with a mask plate so as to form a photoresist reserved region corresponding to a region where the source-drain metal layer pattern 13 is located and a photoresist unreserved region corresponding to the other regions. Next, the photoresist may be developed, so as to fully remove the photoresist at the photoresist unreserved region and maintain a thickness of the photoresist at the photoresist reserved region. Then, the source-drain metal layer at the photoresist unreserved region may be etched off through an etching process, and the remaining photoresist may be removed, so as to form the source-drain metal layer pattern 13. The source-drain metal layer pattern 13 may include drain electrodes, source electrodes and data lines.

Step 8: forming a planarization layer 7. To be specific, an organic resin may be applied onto the base substrate 1 acquired after Step 7 as the planarization layer 7, so as to provide excellent flatness.

Step 9: forming touch electrodes 9.

To be specific, a transparent conative layer having a thickness of about 300 to 1500 Å may be deposited onto the planarization layer 7 through sputtering or thermal evaporation. The transparent conductive layer may be made of indium tin oxide (ITO), indium zinc oxide (IZO) or any other transparent metal oxide. Next, a photoresist may be applied onto the transparent conductive layer, and exposed with a mask plate so as to form a photoresist reserved region corresponding to a region where the touch electrodes 9 are located and a photoresist unreserved region corresponding to the other region. Next, the photoresist may be developed so as to fully remove the photoresist at the photoresist unreserved region and maintain a thickness of the photoresist at the photoresist reserved region. Then, the transparent conductive layer at the photoresist unreserved region may be etched off through an etching process, and the remaining photoresist may be removed, so as to form the touch electrodes 9. Each touch electrode 9 may be multiplexed as a common electrode of the touch display substrate. As shown in FIG. 5, each touch electrode 9 may include a plurality of touch sub-electrodes independent of each other.

Step 10: forming a passivation layer 10. To be specific, the passivation layer 10 having a thickness of 200 to 1000 Å may be deposited onto the base substrate acquired after Step 9 through magnetron-sputtering, thermal evaporation, PECVD or any other film-forming process. The passivation layer may be made of an oxide, a nitride or an oxynitride, e.g., SiNx, SiOx, Si(ON)x, or Al₂O₃. The passivation layer may be of a single-layered structure, or a double-layered structure consisting of silicon nitride and silicon oxide. A reactive gas corresponding to the silicon oxide may be SiH₄ or N₂O, and a reactive gas corresponding to the nitride or the oxynitride may be SiH₄, NH₃ or N₂, or SiH₂Cl₂, NH₃ or N₂. The passivation layer 10 and the planarization layer 7 may be patterned, so as to form a pixel electrode via-hole for exposing each drain electrode and a touch electrode via-hole for exposing each touch electrode.

Step 11: forming pixel electrodes 11 and a conductive protection pattern 16. To be specific, a transparent conductive layer having a thickness of about 300 to 1500 Å may be deposited onto the base substrate 1 acquired after Step 10 through sputtering or thermal evaporation. The transparent conductive layer may be made of ITO, IZO or any other transparent metal oxide. Next, a photoresist may be applied onto the transparent conductive layer, and exposed with a mask plate so as to form a photoresist reserved region corresponding to a region where the pixel electrodes 11 and the conductive protection pattern 16 are located and a photoresist unreserved region corresponding to the other regions. Next, the photoresist may be developed, so as to fully remove the photoresist at the photoresist unreserved region and maintain a thickness of the photoresist at the photoresist reserved region. Then, the transparent conductive layer at the photoresist unreserved region may be etched off through an etching process, and the remaining photoresist may be removed, so as to form the pixel electrodes 11 and the conductive protection pattern 16. Each pixel electrode 11 may be connected to the corresponding drain electrode through the pixel electrode via-hole, and the conductive protection pattern 16 may be connected to each touch electrode 9 through the touch electrode via-hole.

Step 12: forming touch signal lines 12. To be specific, a metal layer having a thickness of about 2000 to 4000 Å may be deposited onto the base substrate 1 acquired after Step 11 through magnetron sputtering, thermal evaporation or any other film-forming process. The metal layer may be made of Cu, Al, Ag, Mo, Cr, Nd, Ni, Mn, Ti, Ta or W, or an alloy thereof, and it may be of a single-layered structure, or a multi-layered structure e.g., Cu/Mo, Ti/Cu/Ti, or Mo/Al/Mo. Next, a photoresist may be applied onto the metal layer, and exposed with a mask plate, so as to form a photoresist reserved region corresponding to a region where the touch signal lines 12 are located and a photoresist unreserved region corresponding to the other regions. Next, the photoresist may be developed, so as to fully remove the photoresist at the photoresist unreserved region and maintain a thickness of the photoresist at the photoresist reserved region. Then, the metal layer at the photoresist unreserved region may be etched off through an etching process, and the remaining photoresist may be removed, so as to form the touch signal lines 12. Each touch signal line 12 may be electrically connected to the corresponding touch electrode 9 via the conductive protection pattern 16.

As shown in FIG. 5, each touch signal line 12 may be connected to one touch sub-electrode through a plurality of touch electrode via-holes 14.

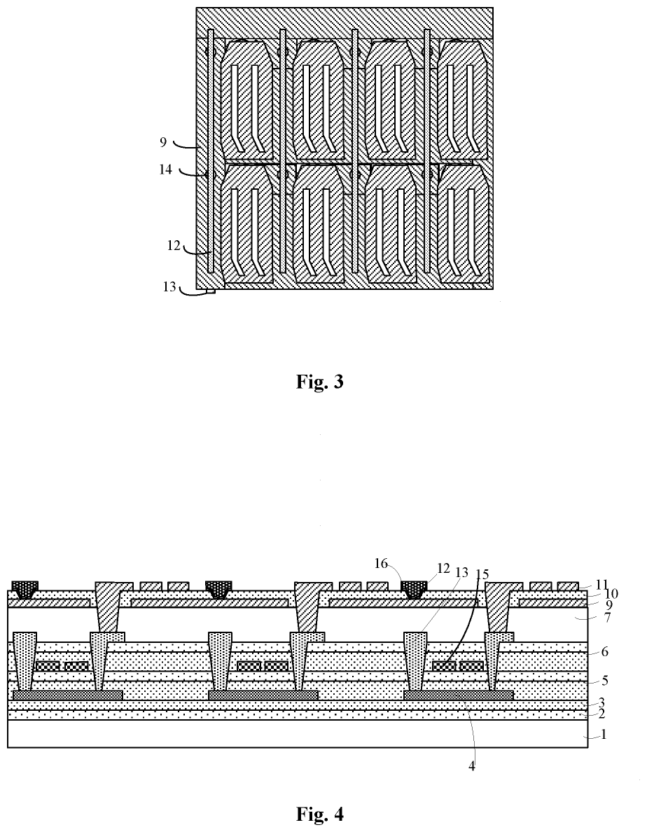

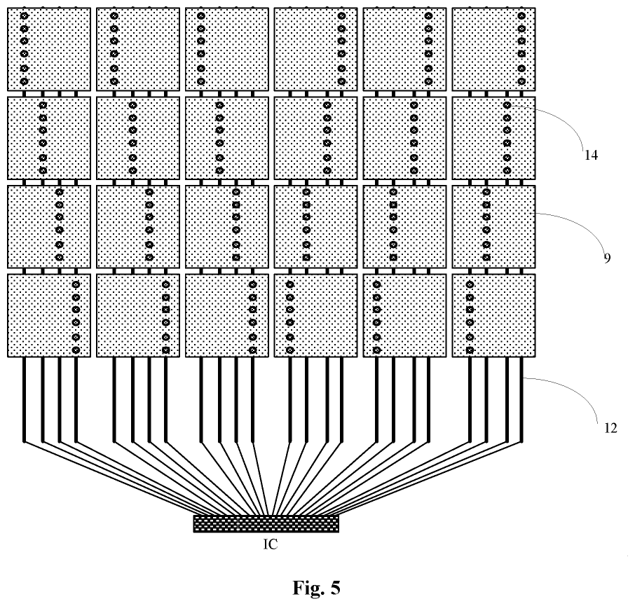

The touch display substrate in FIGS. 3 and 4 may be acquired through the above Steps 1 to 12. The touch display substrate may include, in sequence, the base substrate 1, the light-shielding layer 2 arranged on the base substrate 1, the buffer layer 3 arranged on the light-shielding layer 2, the active layer 4 arranged on the buffer layer 3, the gate insulation layer 5, the intermediate insulation layer 6, the planarization layer 7, the touch electrodes 9 arranged on the planarization layer 7, the passivation layer 10 (i.e., the inorganic insulation layer) covering the touch electrodes 9, the pixel electrodes 11 and the conductive protection pattern 16 arranged on the passivation layer 10, and the touch signal lines 12 arranged on the conductive protection pattern 16.

According to the embodiments of the present disclosure, each touch electrode may be electrically connected to the corresponding touch signal line through the via-hole penetrating through the passivation layer. As compared with the organic resin layer, the passivation layer has a relatively small thickness, which is usually smaller than 1 μm, e.g., several dozen or hundred nanometers, so the lap resistance between the touch electrode and the corresponding touch signal line at the via-hole may be relatively small. In addition, no volatile matter may be generated when the inorganic insulation layer is in the high-temperature or plasma environment, and thereby the electrical connection state at the via-hole may not be adversely affected. As a result, during the display, it is able to apply an equal common voltage signal to the touch electrodes, thereby improve a display effect of the touch display substrate. In addition, during the touch detection, it is able to apply an equal touch signal to the touch electrodes, thereby to ensure a touch effect of the touch display substrate.

Further, due to the relatively small thickness of the passivation layer, the distance between the touch electrode and the pixel electrode at the via-hole in the passivation layer may be slightly different from the distance between the touch electrode and the pixel electrode at the other regions. As a result, during the display, it is able to ensure an intensity of the driving electric field generated between the touch electrode and the pixel electrode at the via-hole, thereby to ensure the capability of the controlling the liquid crystals, and prevent the occurrence of the color display abnormality, e.g., the mura in the oblique direction.

The above embodiments have been described in a progressive manner, and the same or similar contents in the embodiments will not be repeated, i.e., each embodiment merely focuses on the difference from the others. Especially, the method embodiments are substantially similar to the product embodiments, and thus have been described in a simple manner.

Unless otherwise defined, any technical or scientific term used herein shall have the common meaning understood by a person of ordinary skills. Such words as “first” and “second” used in the specification and claims are merely used to differentiate different components rather than to represent any order, number or importance. Similarly, such words as “one” or “one of” are merely used to represent the existence of at least one member, rather than to limit the number thereof. Such words as “include” or “including” intends to indicate that an element or object before the word contains an element or object or equivalents thereof listed after the word, without excluding any other element or object. Such words as “connect/connected to” or “couple/coupled to” may include electrical connection, direct or indirect, rather than to be limited to physical or mechanical connection. Such words as “on”, “under”, “left” and “right” are merely used to represent relative position relationship, and when an absolute position of the object is changed, the relative position relationship will be changed too.

It should be appreciated that, in the case that such an element as layer, film, region or substrate is arranged “on” or “under” another element, it may be directly arranged “on” or “under” the other element, or an intermediate element may be arranged therebetween.

In addition, the features, structures, materials or characteristics may be combined in any embodiment or embodiments in an appropriate manner.

The above embodiments are for illustrative purposes only, but the present disclosure is not limited thereto. Obviously, a person skilled in the art may make further modifications and improvements without departing from the spirit of the present disclosure, and these modifications and improvements shall also fall within the scope of the present disclosure.

1. A touch display substrate, comprising a common electrode, a common electrode line connected to the common electrode, a touch electrode, and a touch signal line connected to the touch electrode, wherein the common electrode is multiplexed as the touch electrode, and the common electrode line is multiplexed as the touch signal line, wherein the touch display substrate further comprises an inorganic insulation layer arranged between the touch electrode and the touch signal line, the touch electrode is electrically connected to the touch signal line through a via-hole penetrating through the inorganic insulation layer, and the touch electrode, the inorganic insulation layer and the touch signal line are stacked in sequence.

2. The touch display substrate according to claim 1, wherein the touch display substrate comprises a plurality of touch signal lines, the touch electrode comprises a plurality of touch sub-electrodes independent of each other and corresponding to the touch signal lines in a one-to-one manner, and each touch sub-electrode is connected to the corresponding touch signal line.

3. The touch display substrate according to claim 1, wherein the inorganic insulation layer has a thickness not greater than 1000 nm.

4. The touch display substrate according to claim 1, wherein the inorganic insulation layer is arranged at a side of the touch electrode away from a base substrate of the touch display substrate, and the touch signal line is arranged at a side of the inorganic insulation layer away from the touch electrode.

5. The touch display substrate according to claim 4, wherein the touch display substrate comprises:
the base substrate;
a thin film transistor (TFT) array arranged on the base substrate;
a planarization layer covering the TFT array;
the touch electrode arranged on the planarization layer,
the inorganic insulation layer covering the touch electrode; and
a pixel electrode and the touch signal line arranged on the inorganic insulation layer, the pixel electrode being connected to a drain electrode of a corresponding TFT through a via-hole penetrating through the planarization layer and the inorganic insulation layer, and the touch signal line being connected to the touch electrode through the via-hole penetrating through the inorganic insulation layer.

6. The touch display substrate according to claim 5, further comprising a conductive protection pattern arranged in the via-hole and in direct contact with the touch electrode, wherein the touch signal line is in direct contact with the conductive protection pattern and electrically connected to the touch electrode via the conductive protection pattern, and the conductive protection pattern and the pixel electrode are formed through a single patterning process.

7. A display device comprising the touch display substrate according to claim 1.

8. A method of manufacturing a touch display substrate, wherein the touch display substrate comprises a common electrode, a common electrode line connected to the common electrode, a touch electrode, and a touch signal line connected to the touch electrode, the common electrode is multiplexed as the touch electrode, and the common electrode line is multiplexed as the touch signal line, wherein the method comprises:
forming one of the touch electrode and the touch signal line;
forming an inorganic insulation layer and forming a via-hole in the inorganic insulation layer through a patterning process; and
forming the other of the touch electrode and the touch signal line, the touch electrode being electrically connected to the touch signal line through the via-hole penetrating through the inorganic insulation layer.

9. The method according to claim 8, wherein the inorganic insulation layer has a thickness not greater than 1000 nm.

10. The method according to claim 8, wherein the method comprises:
forming the touch electrode;
forming the inorganic insulation layer covering the touch electrode, and patterning the inorganic insulation layer to form the via-hole for exposing the touch electrode; and
forming the touch signal line on the inorganic insulation layer, the touch signal line being connected to the touch electrode through the via-hole.

11. The method according to claim 10, wherein prior to forming the touch electrode, the method further comprises:
providing a base substrate and forming a TFT array on the base substrate; and
forming a planarization layer covering the TFT array,
wherein the forming the touch electrode comprises:
forming the touch electrode on the planarization layer, and
wherein subsequent to forming the inorganic insulation layer and prior to forming the touch signal line on the inorganic insulation layer, the method further comprises:
forming a pixel electrode on the inorganic insulation layer, and the pixel electrode being connected to a drain electrode of a TFT through a via-hole penetrating through the planarization layer and the inorganic insulation layer.

12. The method according to claim 11, wherein in a same patterning process for forming the pixel electrode, the method further comprises:
forming a conductive protection pattern in the via-hole and in direct contact with the corresponding touch electrode,
wherein the forming the touch signal line comprises:
forming the touch signal line on the inorganic insulation layer provided with the pixel electrode and the conductive protection pattern, and the touch signal line being in direct contact with the conductive protection pattern and electrically connected to the touch electrode through the conductive protection pattern.
